(19) United States
(12) Patent Application Publication
(10) Pub. No.: US 2026/0342879 A1
(43) Pub. Date: Oct. 29, 2026

(54) DATA COMMUNICATION SYSTEM, CENTER DEVICE, VEHICULAR DEVICE, DATA PROCESSING METHOD, AND DATA PROCESSING PROGRAM

(71) Applicant: DENSO CORPORATION, Kariya-city (JP)

(72) Inventors: Mamoru HOSOKAWA, Kariya-City (KR); Kensho TAKI, Kariya-City (JP); Shinichi KOIKE, Kariya-City (JP)

(21) Appl. No.: 19/709,361

(22) Filed: Jun. 16, 2026

Related U.S. Application Data
(63) Continuation of application No. PCT/JP2024/037397, filed on Oct. 21, 2024.

(30) Foreign Application Priority Data
Dec. 28, 2023 (JP) 2023-222245

(51) Int. Cl. H04L 67/12; H04L 12/40

(52) U.S. Cl. CPC H04L 67/12; H04L 12/40013

(57) ABSTRACT

A data communication system includes a center device and a vehicular device mounted on a vehicle. The center device specifies a trigger condition delivery target for detecting a given scene of a vehicle based on vehicle equipment, generates a trigger condition corresponding to the delivery target, generates a collection data list corresponding to the trigger condition, and delivers the trigger condition and the collection data list to the vehicular device of the delivery target. The vehicular device acquires detection data required for a trigger condition determination, performs the trigger condition determination based on the trigger condition using the detection data, and generates the collection data based on a determination result of the trigger condition determination, and transmits the collection data to the center device.

### CROSS REFERENCE TO RELATED APPLICATION

This application is a continuation application of International Patent Application No. PCT/JP 2024/037397 filed on Oct. 21, 2024, which designated the U.S. and claims the benefit of priority from Japanese Patent Application No. 2023-222245 filed on Dec. 28, 2023. The entire disclosures of all of the above applications are incorporated herein by reference.

### TECHNICAL FIELD

The present disclosure relates to a data communication system, a center device, a vehicular device, a data processing method, and a data processing program.

### BACKGROUND

There is provided a data communication system in which a center device collects vehicle data from an unspecified number of vehicles.

### SUMMARY

According to one aspect of the present disclosure, a data communication system including a center device and a vehicular device mounted on a vehicle is provided. The center device may specify trigger condition delivery target based on vehicle equipment, generate a trigger condition corresponding to the delivery target, generate a collection data list corresponding to the trigger condition, deliver the trigger condition and the collection data list to the vehicular device of the delivery target, and acquire collection data indicated in the collection data list from the vehicular device. The vehicular device may acquire detection data required for a trigger condition determination, perform the trigger condition determination based on the detection data according to the trigger condition, generate the collection data based on a determination result of the trigger condition determination, and transmit the collection data to the center device.

### BRIEF DESCRIPTION OF DRAWINGS

Objects, features and advantages of the present disclosure will become apparent from the following detailed description made with reference to the accompanying drawings. In the drawings:

FIG. 1 is a functional block diagram illustrating an overall configuration of an embodiment;

FIG. 2 is a functional block diagram of a center device;

FIG. 3 is a functional block diagram of a vehicular device;

FIG. 4 is a functional block diagram of a controller unit of a center device;

FIG. 5 is a diagram illustrating a vehicle equipment correspondence table;

FIG. 6 is a diagram illustrating a driver characteristic correspondence table;

FIG. 7 is a diagram illustrating a collection time period correspondence table;

FIG. 8 is a diagram illustrating a trigger condition file;

FIG. 9 is a diagram illustrating a collection data list file;

FIG. 10 is a diagram illustrating a substitute data list file;

FIG. 11 is a functional block diagram of a controller unit of the vehicular device;

FIG. 12 is a flowchart illustrating processes of the vehicular device;

FIG. 13 is a flowchart illustrating processes of the vehicular device;

FIG. 14 is a flowchart illustrating processes of the center device; and

FIG. 15 is a diagram illustrating a flow of processes.

### DETAILED DESCRIPTION

There is provided a data communication system in which a center device collects vehicle data from an unspecified number of vehicular devices by receiving the vehicle data transmitted from the vehicular devices mounted on the unspecified number of vehicles. For example, there is a technology for reducing a transmission frequency of access requests from vehicular devices to a center device and for reducing processing load of authentication for collecting vehicle data.

Users may experience dissatisfaction when using vehicles. An assumed technology for specifying user dissatisfaction may directly or indirectly specify user dissatisfaction. For example, when a Lane Tracing Assist (hereinafter referred to as LTA) function is active during highway driving, it is possible to directly determine that the user experiences dissatisfaction by determining that the user performs a steering operation to cancel the LTA function. For example, by determining that the user has refused to use an auto-parking function in response to a recommendation to use the auto-parking function at start of parking, it is possible to directly determine that the user experiences dissatisfaction. Furthermore, after improving the LTA function based on another user's request, it is possible to indirectly determine that the user experiences dissatisfaction by determining that the behavior of the LTA function logic during operation differs from the behavior of the improved LTA function logic.

In such cases, in order to analyze the scene where the user experienced dissatisfaction, a center device generates a trigger condition for detecting a scene where a user experiences dissatisfaction, and the center device collects from the vehicular device and analyzes such data as sensor values from sensors and control statuses of systems around the time the trigger condition is met. However, data collection from an unspecified number of vehicular devices may lead to such issues as increasing data communication amount and increasing the time and cost required to analyze the collection data.

The present disclosure provides technology for limiting a source of collection data used for analyzing a scene where a user feels dissatisfaction and to efficiently collect the collection data.

According to a first aspect of the present disclosure, a data communication system is provided that comprises a center device and a vehicular device mounted on a vehicle which are capable of data communication with each other. The center device implements: a delivery target specifier that, based on vehicle equipment, specifies a delivery target to which a trigger condition for detecting a given scene of the vehicle is delivered; a trigger condition generator that generates the trigger condition that corresponds to the delivery target; a collection data list generator that generates a collection data list that corresponds to the trigger condition; a deliverer that delivers the trigger condition and the collection data list to the vehicular device of the delivery target; and a data acquirer that acquires collection data indicated in the collection data list from the vehicular device. The vehicular device implements: a detection data acquirer that acquires detection data required for a trigger condition determination; a trigger condition determiner that performs the trigger condition determination based on the detection data according to the trigger condition; a collection data generator that generates the collection data based on a determination result of the trigger condition determination; and a collection data transmitter that transmits the collection data to the center device.

According to a second aspect of the present disclosure, a center device capable of data communication with a vehicular device mounted on a vehicle is provided, wherein the vehicular device performs a trigger condition determination based on detection data required for the trigger condition determination, generates collection data based on a determination result of the trigger condition determination, and transmits the collection data to the center device. The center device implements: a delivery target specifier that, based on vehicle equipment, specifies a delivery target to which a trigger condition for detecting a given scene of the vehicle is to be delivered; a trigger condition generator that generates the trigger condition that corresponds to the delivery target; a collection data list generator that generates a collection data list that corresponds to the trigger condition; a deliverer that delivers the trigger condition and the collection data list to the vehicular device of the delivery target; and a data acquirer that acquires the collection data from the vehicular device.

According to a third aspect of the present disclosure, a vehicular device mounted on a vehicle and capable of data communication with a center device is provided, wherein the center device specifies a delivery target to which a trigger condition for detecting a given scene of the vehicle is to be delivered based on vehicle equipment, generates the trigger condition corresponding to the delivery target, generates a collection data list corresponding to the trigger condition, delivers the trigger condition and the collection data list to the vehicular device of the delivery target, and acquires collection data from the vehicular device. The vehicular device implements: a detection data acquirer that acquires detection data required for a trigger condition determination; a trigger condition determiner that performs the trigger condition determination based on the detection data according to the trigger condition; a data collector that generates the collection data based on a determination result of the trigger condition determination; and a collection data transmitter that transmits the collection data to the center device.

According to a fourth aspect of the present disclosure, a data processing method executed in a data communication system in which a center device and a vehicular device mounted on a vehicle are capable of data communication is provided. The data processing method comprises by the center device: based on vehicle equipment, specifying a delivery target to which a trigger condition for detecting a given scene of the vehicle is delivered; generating the trigger condition that corresponds to the delivery target; generating a collection data list that corresponds to the trigger condition; delivering the trigger condition and the collection data list to the vehicular device of the delivery target; and acquiring collection data indicated in the collection data list from the vehicular device. The data processing method further comprises by the vehicular device: acquiring detection data required for a trigger condition determination; performing the trigger condition determination based on the detection data; generating collection data based on a determination result of the trigger condition determination; and transmitting the collection data to the center device.

According to a fourth aspect of the present disclosure, a data processing method executed in a center device capable of data communication with a vehicular device mounted on a vehicle is provided, wherein the vehicular device performs a trigger condition determination based on detection data required for the trigger condition determination, generates collection data based on a determination result of the trigger condition determination, and transmits the collection data to the center device. The data processing method comprises: specifying a delivery target to which a trigger condition for detecting a given scene of the vehicle is delivered; generating the trigger condition that corresponds to the delivery target; generating a collection data list that corresponds to the trigger condition; delivering the trigger condition and the collection data list to the vehicular device of the delivery target; and acquiring the collection data from the vehicular device.

According to a sixth aspect of the present disclosure, a data processing method executed in a vehicular device mounted on a vehicle and capable of data communication with a center device is provided, wherein the center device specifies a delivery target to which a trigger condition for detecting a given scene of the vehicle is to be delivered based on vehicle equipment, generates the trigger condition corresponding to the delivery target, generates a collection data list corresponding to the trigger condition, delivers the trigger condition and the collection data list to the vehicular device of the delivery target, and acquires collection data from the vehicular device. The data processing method comprises: acquiring detection data required for a trigger condition determination; performing the trigger condition determination based on the detection data; generating collection data based on a determination result of the trigger condition determination; and transmitting the collection data to the center device.

According to a seventh aspect of the present disclosure, a data processing program for a center device capable of data communication with a vehicular device mounted on a vehicle is provided, wherein the vehicular device performs a trigger condition determination based on detection data required for the trigger condition determination, generates collection data based on a determination result of the trigger condition determination, and transmits the collection data to the center device. The data processing program causes the center device to execute: based on vehicle equipment, specifying a delivery target to which a trigger condition for detecting a given scene of the vehicle is delivered; generating the trigger condition that corresponds to the delivery target; generating a collection data list that corresponds to the trigger condition; delivering the trigger condition and the collection data list to the vehicular device of the delivery target; and acquiring the collection data from the vehicular device,

According to an eight aspect of the present disclosure, a data processing program for a vehicular device mounted on a vehicle and capable of data communication with a center device is provided, wherein the center device specifies a delivery target to which a trigger condition for detecting a given scene of the vehicle is to be delivered based on vehicle equipment, generates the trigger condition corresponding to the delivery target, generates a collection data list corresponding to the trigger condition, delivers the trigger condition and the collection data list to the vehicular device of the delivery target, and acquires collection data from the vehicular device. The data processing program causes the vehicular device to execute: acquiring detection data required for a trigger condition determination; performing the trigger condition determination based on the detection data; generating collection data based on a determination result of the trigger condition determination; and transmitting the collection data to the center device.

According to the above, it is possible to limit a source of collection data used for analyzing a scene where a user feels dissatisfaction and to efficiently collect the collection data.

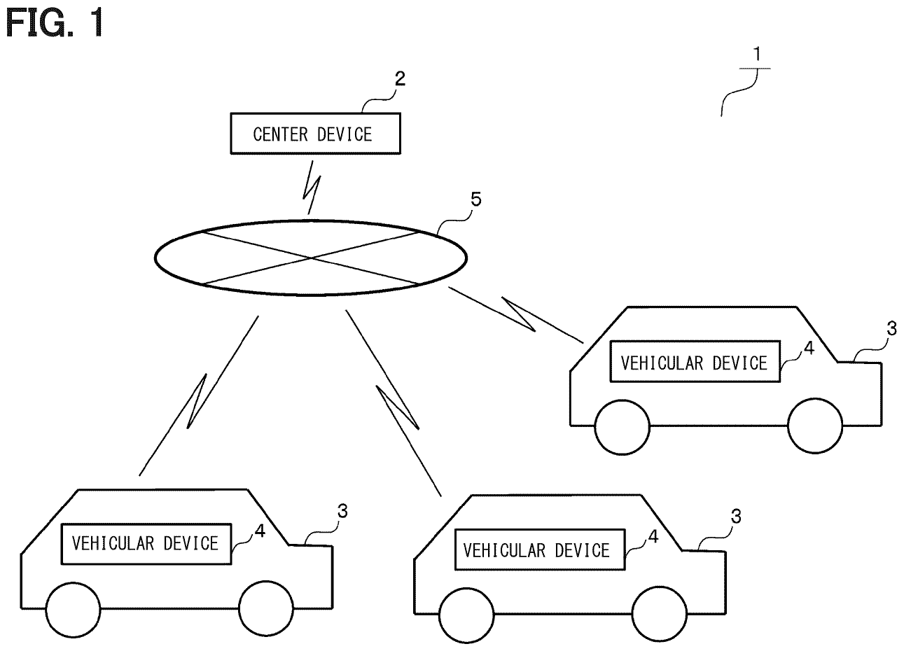

Hereinafter, embodiments will be described with reference to the drawings. As shown in FIG. 1, a data communication system 1 is configured such that a center device 2 and vehicular devices 4 individually mounted on multiple vehicles 3 are capable of data communication via a wide-area wireless communication network 5.

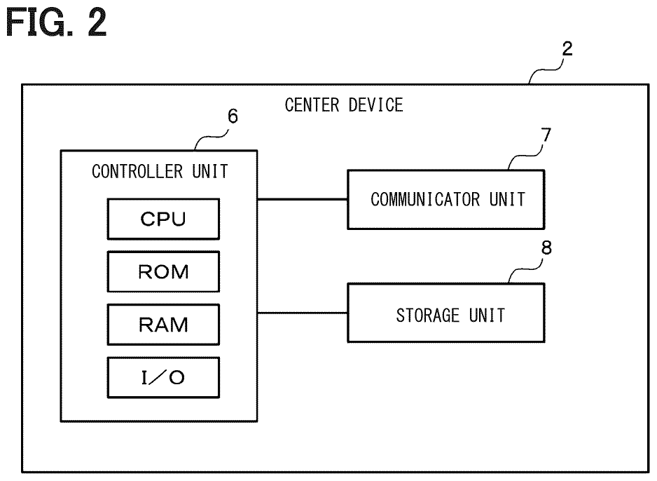

As shown in FIG. 2, the center device 2 includes a controller unit 6, a communicator unit 7, and a storage unit 8. The controller unit 6 includes, as its main component, a microcomputer (hereinafter referred to as a microcontroller) including a CPU, ROM, RAM, and I/O and executes controls via software processing by the CPU executing a computer program stored in a non-transitory tangible storage medium, and hardware processing by a dedicated electronic circuit, thereby controlling operations of the center device 2. A method corresponding to the computer program is executed by executing the computer program. The number of microcontrollers in the controller unit 6 may be one or more. The communicator unit 7 controls the data communication with the multiple vehicular devices 4 via the wide-area wireless communication network 5. The storage unit 8 stores various data.

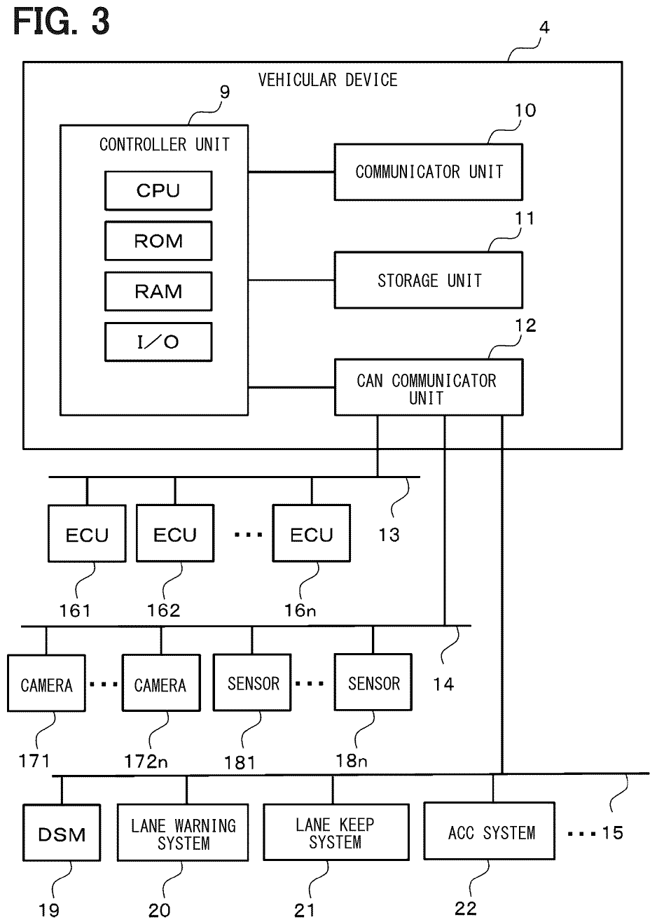

As shown in FIG. 3, the vehicular device 4 includes a controller unit 9, a communicator unit 10, a storage unit 11, and a CAN (Controller Area Network) communicator unit 12. The controller unit 9 includes, as its main component, a microcontroller including a CPU, ROM, RAM, and I/O, and executes controls via software processing by the CPU executing a computer program stored in a non-transitory tangible storage medium, and hardware processing by a dedicated electronic circuit, thereby controlling operations of the vehicular device 4. A method corresponding to the computer program is executed by executing the computer program. The number of microcontrollers in the controller unit 9 may be one or more. The communicator unit 10 controls the data communication with the center device 2 via the wide-area wireless communication network 5. The storage unit 11 stores various data.

The CAN communicator unit 12 connects to CAN buses 13 to 15. The CAN communicator unit 12 is connected to multiple ECUs 161 to 16n via the CAN bus 13 in a data communicable manner. The multiple ECUs 161 to 16n include, for example, an engine ECU for engine control, an accelerator ECU for accelerator control, a brake ECU for brake control, a steering ECU for steering control, a meter ECU for meter control, and a navigation ECU for navigation control. For example, the accelerator ECU transmits data indicating accelerator opening as the detection data to the CAN communicator unit 12. For example, the brake ECU transmits data indicating a brake pedal operation amount as the detection data to the CAN communicator unit 12. For example, the steering ECU transmits data indicating the angular velocity of the steering wheel as the detection data to the CAN communicator unit 12. For example, the navigation ECU transmits data indicating the latitude and longitude as the detection data to the CAN communicator unit 12. ECUs of the multiple ECUs 161 to 16n are connected to the same single bus for each system. For example, ECUs for a ADAS (Advanced Driving Assistant System) are connected to a same single bus, ECUs for a body system are connected to a same single bus, ECUs for a chassis system are connected to a same single bus.

The CAN communicator unit 12 is connected via the CAN bus 14 to multiple cameras 171 to 17n and multiple sensors 181 to 18n in a data communicable manner. The multiple cameras 171 to 17n include, for example, a front camera for imaging an area forward of the vehicle, a vehicle inside camera for imaging an inside of the vehicle, and a driver camera for imaging the driver. For example, the front camera, which images the area forward of the vehicle, transmits data indicating the captured image of the area forward of the vehicle as the detection data to the CAN communicator unit 12. For example, the vehicle inside camera transmits data indicating the captured image of the vehicle inside as the detection data to the CAN communicator unit 12. The multiple sensors 181 to 18n include, for example, a LIDAR (Light Detection and Ranging, Laser Imaging), a millimeter-wave radar, an ultrasonic sensor, an illuminance sensor, a rain sensor, etc. For example, the sensor for detecting an area forward of the vehicle, such as the LIDAR or the millimeter-wave radar, transmits data indicating a distance to a preceding vehicle as the detection data to the CAN communicator unit 12. For example, the illuminance sensor transmits data indicating illuminance as the detection data to the CAN communicator unit 12. For example, the rain sensor transmits data indicating a rainfall amount as the detection data to the CAN communicator unit 12.

The CAN communicator unit 12 is connected via the CAN bus 15 to a DSM (Driver Status Monitor) 19, a lane warning system 20, a lane keep system 21, an ACC (Adaptive Cruise Control) system 22, and other systems in a data communicable manner. For example, the DSM 19 transmits data indicating a driver's status as the detection data to the CAN communicator unit 12. For example, the lane warning system 20 transmits data indicating a control status of the lane warning system 20 as the detection data to the CAN communicator unit 12. For example, the lane keep system 21 transmits data indicating a control status of the lane keep system 21 as the detection data to the CAN communicator unit 12. For example, the ACC system 22 transmits data indicating a control status of the ACC system 22 as the detection data to the CAN communicator unit 12.

The number of CAN buses 13 to 15 connected to the CAN communicator unit 12 is not limited to three; it may be two or less, or four or more. A form in which various ECUs 161 to 16n, various cameras 171 to 17n, various sensors 181 to 18n, the DSM 19, and various systems 20 to 22 are connected to the CAN buses 13 to 15 may be any form. Various devices connected to the CAN bus 13 to 15 are not limited to the ECUs, the cameras, the sensors, and the systems described above. Furthermore, an in-vehicle communication network used is not limited to the CAN buses 13 to 15 but may be a configuration using Ethernet, etc. Ethernet is a registered trademark.

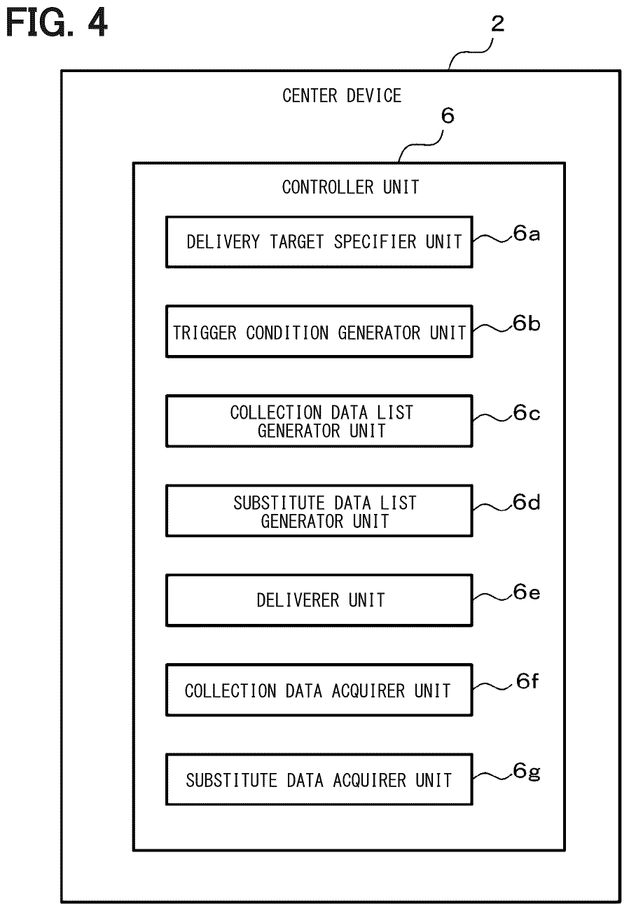

As shown in FIG. 4, on a function basis, the controller unit 6 in the center device 2 includes a delivery target specifier unit 6a, a trigger condition generator unit 6b, a collection data list generator unit 6c, a substitute data list generator unit 6d, a deliverer unit 6e, a collection data acquirer unit 6f, and a substitute data acquirer unit 6g. These components 6a to 6g execute a data processing method of the center device 2 and execute a data processing program of the center device 2.

The delivery target specifier unit 6a specifies a delivery target to which a trigger condition for detecting a scene where a user feels dissatisfaction (corresponding to a given scene of the vehicle) is to be delivered, based on vehicle equipment, a driver characteristic, and a data collection time period.

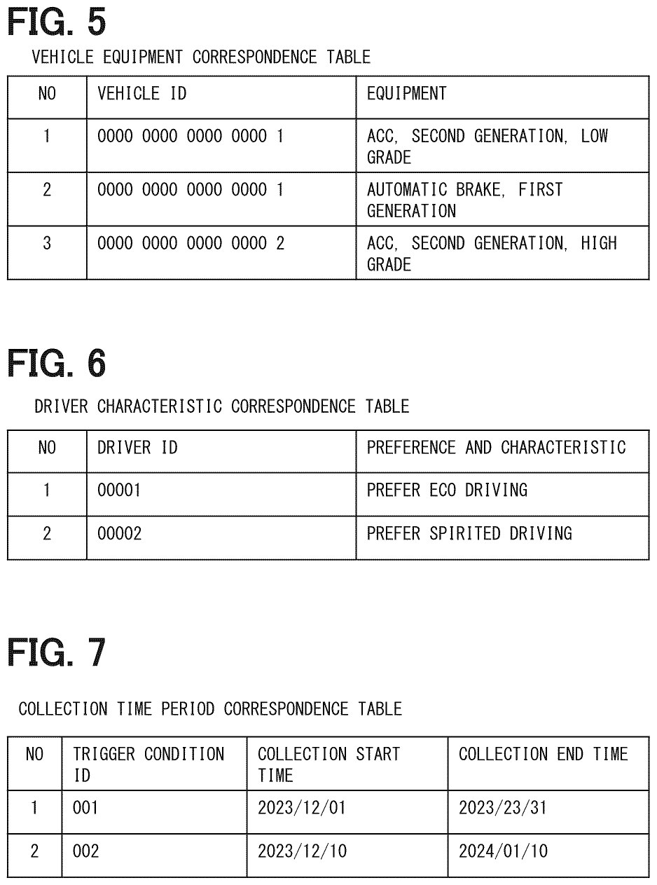

The delivery target specifier unit 6a generates a vehicle equipment correspondence table as shown in FIG. 5 and specifies the trigger condition delivery target based on this generated vehicle equipment correspondence table. For example, in the case of using the trigger condition for “ACC, second-generation, low grade”, the delivery target specifier unit 6a specifies that the vehicle having the vehicle ID “the vehicle ID “0000 0000 0000 0000 1” is the delivery target and the vehicle having the vehicle ID “the vehicle ID “0000 0000 0000 0000 2” is not the delivery target. The vehicle ID is vehicle identifier information for identifying the vehicle. The target specifier unit 6a generates a driver characteristic correspondence table as shown in FIG. 6 and specifies the delivery target based on the generated driver characteristic correspondence table. In the case of using the trigger condition for “preferring spirited driving” for example, the delivery target specifier unit 6a specifies that the vehicle with the driver of the driver ID “00002” onboard is the delivery target and the vehicle with the driver of the driver ID “00001” onboard is not the delivery target. The driver ID is driver identification information for identifying the driver. The delivery target specifier unit 6a generates a collection time period correspondence table as shown in FIG. 7 and specifies the trigger condition delivery target based on the generated collection time period correspondence table. The delivery target specifier unit 6a specifies that a target time period for delivering the trigger condition “trigger condition ID: 001” is from Dec. 1, 2023, to Dec. 31, 2023.

The trigger condition generator unit 6b generates the trigger condition. The collection data list generator unit 6c generates the collection data list. The substitute data list generator unit 6d generates the substitute data list. The deliverer unit 6e delivers the trigger condition generated by the trigger condition generator unit 6b, the collection data list generated by the collection data list generator unit 6c, and the substitute data list generated by the substitute data list generator unit 6d from the communicator unit 7 to the vehicular device 4. The data acquirer unit 6f acquires the collection data from the vehicular device 4 by receiving at the communicator unit 7 the collection data transmitted from the vehicular device 4. The substitute data acquirer unit 6g acquires the substitute data from the vehicular device 4 by receiving at the communicator unit 7 the substitute data transmitted from the vehicular device 4.

The following is an example of the trigger condition and the collection data:
“Trigger Condition”,
Vehicle Equipment (ACC): ACC, Second Generation, Low Grade,
Driver characteristic: Prefers spirited driving,
Collection Time Period: Dec. 1, 2023, to Dec. 31, 2023,
Control Status of ACC system: In operation,
Accelerator opening: ≥30%; and
“Collection Data”,
from 60 seconds prior to trigger condition establishment, latitude and longitude, and steering wheel angular velocity by user.

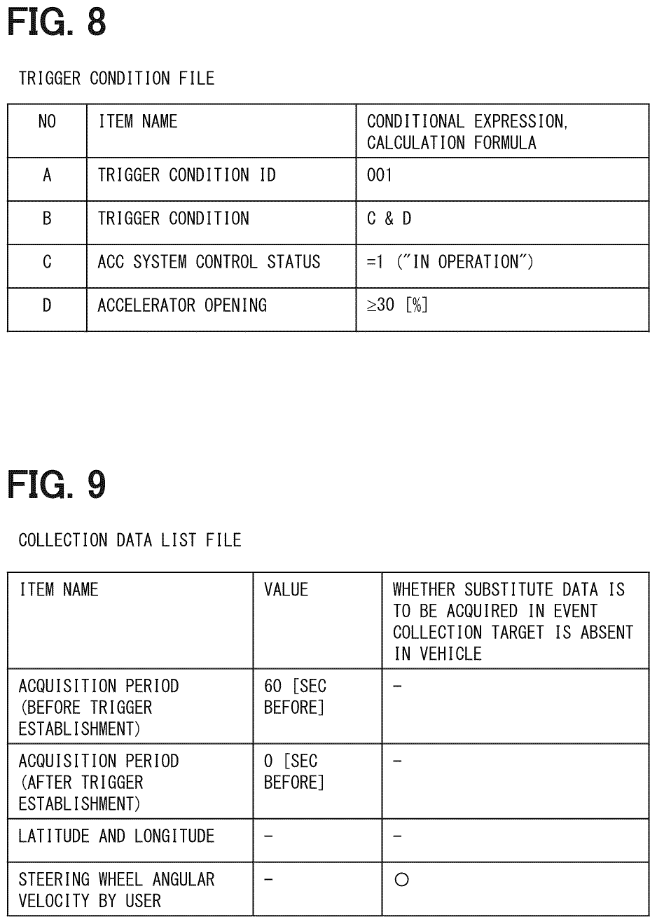

The trigger condition generator unit 6b generates a trigger condition file and generates the trigger condition, as shown in FIG. 8. The trigger condition file illustrated in FIG. 8 contains the following items: the trigger condition ID, the trigger condition, the ACC control, and the accelerator opening.

The collection data list generator unit 6c generates a collection data list file and generates the collection data list, as shown in FIG. 9. The collection data list file shown in FIG. 9 contains the following items: acquisition time period (before trigger establishment), acquisition time period (after trigger establishment), latitude and longitude, and steering wheel angular velocity by the user. In the example shown in FIG. 9; the latitude and longitude are marked as “-” and it is not stipulated that the substitute data be acquired; and the steering wheel angular velocity by user is marked as “○” and it is stipulated that the substitute data be acquired.

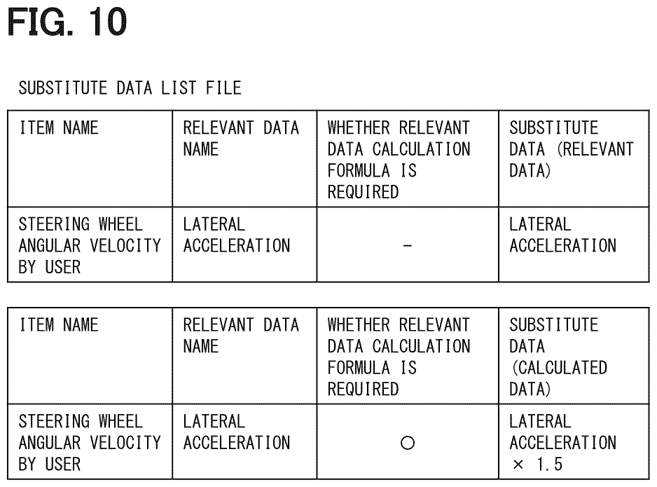

The substitute data list generator unit 6d generates a substitute data list file and generates the substitute data list, as shown in FIG. 10. The substitute data list file shown in FIG. 10 includes, as an item, the steering wheel angular velocity by user. In the example shown in FIG. 10, lateral acceleration is stipulated as a relevant data name. If “-” is marked for whether a relevant data calculation formula is required, it is stipulated that the calculation formula be not required and that the relevant data be the substitute data. If “○” is marked for whether a relevant data calculation formula is required, it is stipulated that the calculation formula be required and that the substitute data be a calculated data which is data calculated based on the relevant data.

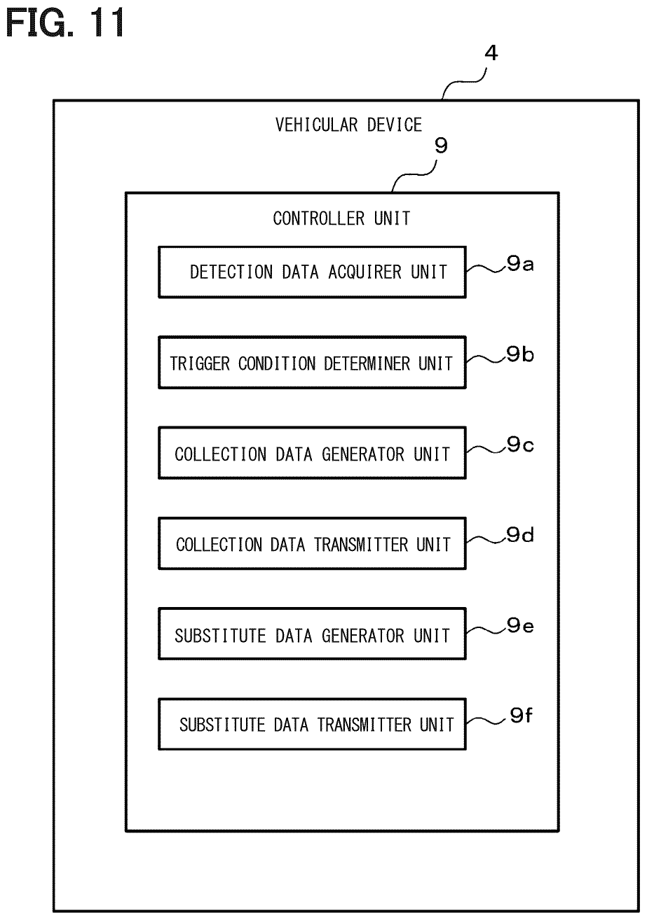

As shown in FIG. 11, on a functional basis, the controller unit 9 of the vehicular device 4 includes a detection data acquirer unit 9a, a trigger condition determiner unit 9b, a collection data generator unit 9c, a collection data transmitter unit 9d, a substitute data generator unit 9e, and a substitute data transmitter unit 9f. These components 9a to 9f execute a data processing method of the vehicular device 4 and execute a data processing program of the vehicular device 4.

The detection data acquirer unit 9a acquires the detection data required for the trigger condition determination. In the case of determining the control status of the ACC system 22 for example, the detection data acquirer unit 9a acquires data indicating the control status of the ACC system 22 as the detection data from the ACC system 22. In the case of determining the accelerator opening for example, the detection data acquirer unit 9a acquires data indicating the accelerator opening as the detection data from the accelerator ECU.

Upon the detection data acquirer unit 9a acquiring the detection data, the trigger condition determiner unit 9b performs the trigger condition determination based on the acquired detection data. The data collector unit 9c generates the collection data based on a determination result of the trigger condition determination. Upon the data collector unit 9c generating the collection data, the collection data transmitter unit 9d transmits the collection data generated by the collection data generator unit 9c from the communicator unit 10 to the center device 2. The substitute data generator unit 9e generates the substitute data when the collection data generator unit 9c is unable to generate the collection data based on the trigger condition determination result. The substitute data transmitter unit 9f transmits the substitute data generated by the substitute data generator unit 9e from the communicator unit 10 to the center device 2.

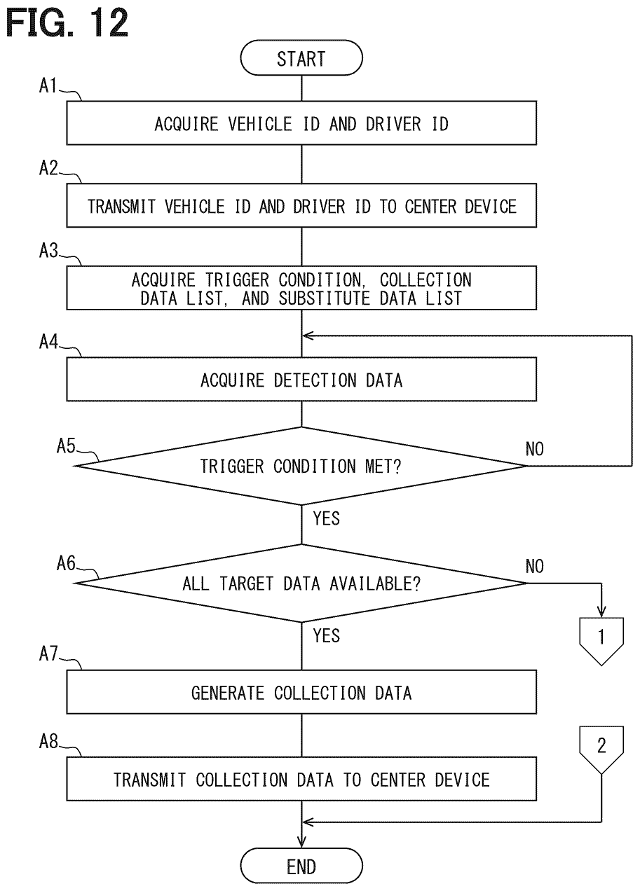

Next, the operation of the above-described configuration will be described with reference to FIGS. 12 to 15. Now, a process performed by the controller unit 9 of the vehicular device 4 and a process performed by the controller unit 6 of the center device 2 will be described.

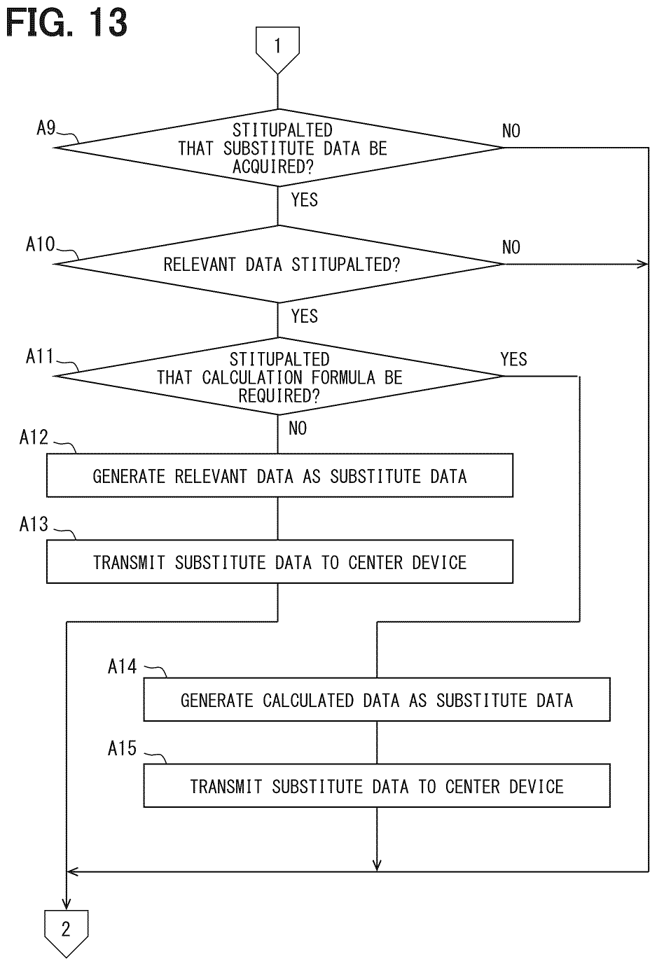

(1) Process performed by controller unit 9 of vehicular device 4 (see FIGS. 12 to 13).

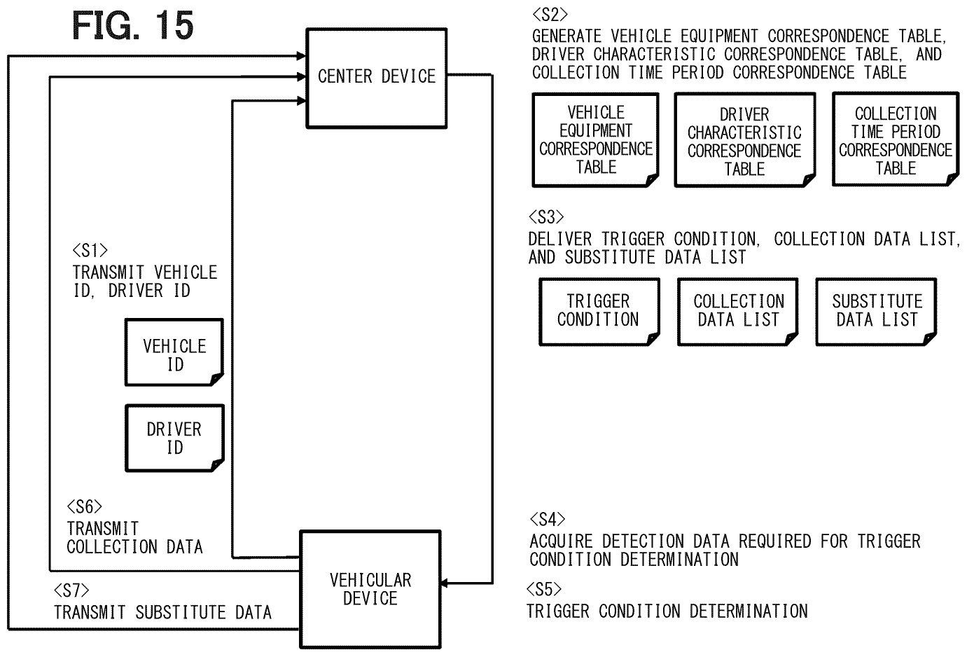

In the vehicular device 4, the controller unit 9 starts the vehicle-side process. Upon detecting, for example, a user boarding the vehicle and detecting ignition ON (corresponding to a drive mechanism starting operating), the controller unit 9 acquires the vehicle ID unique to the vehicle that the user is in and the driver ID unique to the user onboard (A1). The controller unit 9 transmits the acquired vehicle ID and driver ID from the communicator unit 10 to the center device 2 (A2, S1 shown in FIG. 15) and waits to receive the trigger condition, the collection data list, and the substitute data list from the center device 2.

By receiving at the communicator unit 10 the trigger condition, the collection data list, and the substitute data list transmitted from the center device 2, the controller unit 9 acquires the trigger condition, the collection data list, and the substitute data list from the center device 2 (A3). The controller unit 9 then acquires the detection data required for the trigger condition determination (A4, S4 in FIG. 15, corresponding to a detection data acquisition procedure). The controller unit 9 determines whether the trigger condition is met (A5, S5 in FIG. 15, corresponding to a trigger condition determination procedure). If the controller unit 6 determines that the trigger condition is met (A5: YES), the controller unit 6 then determines whether all the collection targets are available (A6).

If the controller unit 9 determines that all the collection targets are available (A6: YES), the controller unit 9 then generates the collection data (A7, corresponding to a collection data generation procedure), transmits the generated collection data from the communicator unit 10 to the center device 2 (A8, S6 in FIG. 15, corresponding to a collection data transmission procedure), and ends the vehicle-side process.

The controller unit 9 determines that the above-illustrated trigger condition is met if the following is met:
Vehicle Equipment (ACC): ACC, Second Generation Low Grade,
Driver characteristics: Prefers spirited driving,
Collection Time Period: Dec. 1, 2023, to Dec. 31, 2023,
ACC system control status: In operation, and
Accelerator opening: ≥30%.

Specifically, the controller unit 9 determines that the trigger condition is met if, while the ACC system is in operation, the user performs an accelerator pedal operation causing the accelerator opening to be greater than or equal to 30. When the latitude and longitude and the steering wheel angular velocity by the user are available for the collection data, the controller unit 9 generates the following data as the collection data: from 60 seconds prior to the trigger condition establishment, the latitude and longitude and the steering wheel angular velocity by the user, The controller unit 9 transmits the generated collection data to the center device 2 via the communicator unit 10. Specifically, upon determining that the trigger condition is met, the controller unit 9 transmits the data before and after the user feels dissatisfaction to the center device 2, wherein the data includes the latitude and longitude and the steering wheel angular velocity by the user.

If the controller unit 9 determines that not all the collection target data is available (A6: NO), the controller unit 9 then determines whether it is stipulated that the substitute data be acquired (A9). If the controller unit 9 determines that it is stipulated that the substitute data be acquired (A9), the controller unit 9 then determines whether the relevant data is stipulated (A10). If the controller unit 9 determines that the relevant data is stipulated (A10: YES), the controller unit 9 then determines whether the calculation formula is required (A11). If the controller unit 9 determines that the calculation formula is not required (A11: NO), the controller unit 9 then generates the relevant data as the substitute data (A12), transmits the generated substitute data from the communicator unit 10 to the center device 2 (A13, S7 shown in FIG. 15), and ends the vehicle-side process.

If the lateral acceleration is defined as the relevant data for the steering wheel angular velocity by the user and the calculation formula is not required, the controller unit 9 generates the following data as the substitute data: from before 60 seconds prior to the trigger condition establishment, the longitude and latitude and the lateral acceleration. The controller unit 9 transmits the generated substitute data from the communicator unit 10 to the center device 2. Specifically, upon determining that the trigger condition is met, the controller unit 9 transmits the data before and after the user feels dissatisfaction to the center device 2, wherein the data includes the latitude and longitude and the lateral acceleration.

If the controller unit 9 determines that the calculation formula is required (A11: YES), the controller unit 9 then generates the calculated data as the substitute data, wherein the calculated data is data based on the relevant data (A14). The controller unit 9 transmits the generated substitute data from the communicator unit 10 to the center device 2 (A15, S7 shown in FIG. 15) and ends the vehicle-side process.

When it is stipulated that the lateral acceleration should be the relevant data for the steering wheel angular velocity by the user and that the calculation formula be required, the controller unit 9 generates the following data as the substitute data: from before 60 seconds prior to the trigger condition establishment, the latitude and longitude and the lateral acceleration multiplied by 1.5. The controller unit 9 transmits the generated substitute data from the communicator unit 10 to the center device 2. Specifically, upon determining that the trigger condition is met, the controller unit 9 transmits the data before and after the user feels dissatisfaction to the center device 2, wherein the data includes the latitude and longitude and the lateral acceleration multiplied by 1.5.

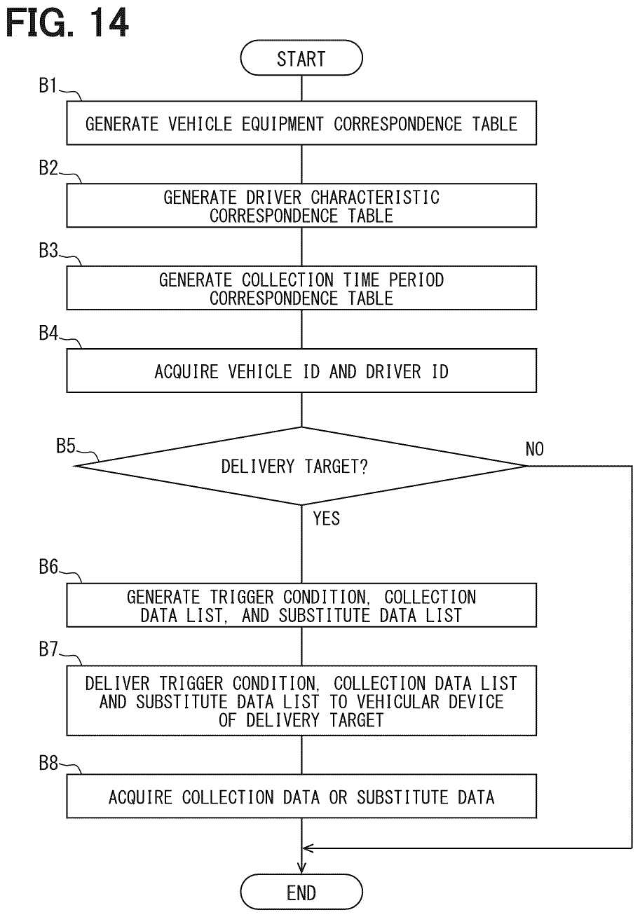

(2) Process performed by controller unit 6 of center device 2 (see FIG. 14).

In the center device 2, upon start of the center-side process, the controller unit 6 generates the vehicle equipment correspondence table (B1), generates the driver characteristic correspondence table (B2), and generates the collection time period correspondence table (B3). The controller unit 6 acquires the vehicle ID and the driver ID by receiving at the communicator unit 7 the vehicle ID and the driver ID transmitted from the center device 2 (B4) and then determines whether it is the delivery target (B5).

If the controller unit 6 determines that it is the delivery target (B5: YES, corresponding to a delivery target specifying procedure), the controller unit 6 then generates the trigger condition, the collection data list, and the substitute data list (B6, corresponding to a trigger condition generation procedure and a collection data list generation procedure). The controller unit 6 delivers the generated trigger condition, the collection data list, and the substitute data list from the communicator unit 7 to the vehicular device 4 of the delivery target (B7, S2 in FIG. 15, corresponding to a delivery procedure), and waits to receive the collection data or the substitute data from the vehicular device 4.

The controller unit 6 acquires the collection data or the substitute data by receiving at the communicator unit 10 the collection data or the substitute data transmitted from the vehicular device 4 (B8, corresponding to a collection data acquisition procedure), and ends the center-side process. After that, the collection data or the substitute data acquired from the vehicular device 4 may be analyzed and thereby the scene where the felt the dissatisfaction may be analyzed. If the controller unit 6 determines that it is not the delivery target (B6: NO), the controller unit 6 then ends the center-side process without generating the trigger condition, the collection data list, nor the substitute data list.

The above examples illustrate specifying the delivery target based on the vehicle equipment, the driver's characteristic, and the collection time period. Alternatively, the delivery target may be specified based on the vehicle equipment alone, based on both the vehicle equipment and the driver's characteristics, or based on both the vehicle equipment and the collection time period. The above illustrates the example in which in response to the ignition ON in the vehicle, the center device 2 delivers the trigger condition, the collection data list and the substitute data list to the vehicular device 4 of the delivery target. Alternatively, in response to completing software update in the electronic control unit of the vehicle or in response to changing drivers, the center device 2 may deliver the trigger condition, the collection data list, and the substitute data list to the vehicular device 4 of the delivery target.

The above illustrates a configuration example in which: the vehicular device 4 acquires the driver ID unique to the user who is in the vehicle and transmits the driver ID to the center device 2; and the vehicular device 4 generates the collection data or the substitute data and transmits it to the center device 2 in response to receiving the collection data list, the substitute data list and the trigger condition corresponding to the driver characteristic from the center device 2. To the center device 2, the vehicular device 4 may transmit a list of pre-registered driver IDs of users who may get on the vehicle. From the center device 2, the vehicular device 4 may acquire the trigger conditions corresponding to the driver characteristics linked to the respective drivers ID included in the list, the collection data lists, and the substitute data lists and store them. In response to a user boarding the vehicle, the vehicular device 4 may acquire the driver ID of this user and may generate the collection data or the substitute data based on the trigger condition, the collection data list, and the substitute data list corresponding to this driver ID and may transmit the collection data or the substitute data to the center device 2. In this configuration, the center device 2 may enable the vehicular device 4 to identify the correspondence with the driver ID by including the driver ID in each of the trigger conditions, the collection data lists, and the substitute data lists. Furthermore, in addition to transmitting the list of driver IDs of pre-registered users who may get on the vehicle, another information communication terminal may transmit the list of driver IDs associated with the vehicular device 4 to the center device 2.

The embodiments described above provide the following operational effects. The center device 2 specifies the delivery target to which the trigger condition for detecting the scene where the user feels dissatisfaction is to be delivered, based on the vehicle equipment, the driver characteristic and the collection time period. The center device 2 delivers the trigger condition, the collection data list, and the substitute data list to the vehicular device 4 of the delivery target. The vehicular device 4 performs the trigger condition determination according to the trigger condition, generates the collection data based on the determination result and transmits the collection data to the center device 2. It is possible to limit a source of the collection data used for analyzing a scene where a user feels dissatisfaction and to efficiently collect the collection data.

By specifying the trigger condition delivery target based not only on the vehicle equipment but also on the driver's characteristic, it is possible to limit the source of the collection data by using the vehicle equipment and the driver's characteristic. By specifying the trigger condition delivery target based on not only the vehicle equipment but also on the collection time period, it is possible to limit the source of the collection data by using the vehicle equipment and the collection time period.

While the present disclosure has been described with reference to embodiments thereof, it is to be understood that the disclosure is not limited to the embodiments and constructions. The present disclosure also encompasses various modifications and variations within equivalents. Additionally, various combinations and configurations, as well as other combinations and configurations, including only a single element, more, or less, are within the scope and spirit of the present disclosure.

The controller units and methods thereof described in the present disclosure may be implemented by a special purpose computer provided by configuring a memory and processor programmed to perform one or more functions embodied in a computer program. Alternatively, the controller units and methods thereof described in the present disclosure may be implemented by a special purpose computer provided by configuring a processor with one or more dedicated hardware logic circuits. Alternatively, the controller units and methods thereof described in the present disclosure may be implemented by one or more special purpose computers provided by configuring a memory and processor programmed to perform one or more functions in combination with configuring a processor with one or more hardware logic circuits. The computer program may be stored in a computer-readable non-transitory tangible storage medium as instructions executed by a computer.

In addition to the claims, the present disclosure encompasses the following.
[1]. A data communication system (1) comprises:
a center device (2); and a vehicular device (4) mounted on a vehicle which are capable of data communication with each other,
wherein the center device includes:
a delivery target specifier unit (6a) that, based on vehicle equipment, specifies a delivery target to which a trigger condition for detecting a given scene of the vehicle is delivered;
a trigger condition generator unit (6b) that generates the trigger condition that corresponds to the delivery target;
a collection data list generator unit (6c) that generates a collection data list that corresponds to the trigger condition;
a deliverer unit (6e) that delivers the trigger condition and the collection data list to the vehicular device of the delivery target; and
a data acquirer unit (6f) that acquires collection data indicated in the collection data list from the vehicular device, and
wherein the vehicular device includes:
a detection data acquirer unit (9a) that acquires detection data required for a trigger condition determination;
a trigger condition determiner unit (9b) that performs the trigger condition determination based on the detection data according to the trigger condition;
a collection data generator unit (9c) that generates the collection data based on a determination result of the trigger condition determination; and
a collection data transmitter unit (9d) that transmits the collection data to the center device.
[2]. In the data communication system according to [1],
the delivery target specifier unit specifies the delivery target based on a driver characteristic in addition to the vehicle equipment.
[3]. In the data communication system according to [1] or [2],
the delivery target specifier unit specifies the delivery target based on a collection time period for collecting the collection data in addition to the vehicle equipment.
[4]. In the data communication system according to any one of [1] to [3],
the deliverer unit delivers the trigger condition and the collection data list to the vehicular device of the delivery target in response to a driving mechanism starting operating in the vehicle of the delivery target.
[5]. In the data communication system according to any one of [1] to [4],
the deliverer unit delivers the trigger condition and the collection data list to the vehicular device of the delivery target in response to completing a software update of an electronic control unit in the vehicle of the delivery target.
[6]. In the data communication system according to any one of [1] to [5],
the deliverer unit delivers the trigger condition and the collection data list to the vehicular device of the delivery target in response to changing drivers in the vehicle of the delivery target.
[7]. In the data communication system according to any one of [1] to [5],
the center device further includes:
a substitute data list generator unit (6d) that generates a substitute data list serving as a substitute for the collection data list; and
a substitute data acquirer unit (6g) that acquires substitute data indicated in the substitute data list from the vehicular device,
the deliverer unit delivers the trigger condition, the collection data list, and the substitute data list to the vehicular device of the delivery target,
the vehicular device further includes:
a substitute data generator unit (9e) that generates the substitute data when the collection data generator unit is unable to generate the collection data based on the determination result of the trigger condition determination; and
a substitute data transmitter unit (9f) that transmits the substitute data to the center device.
[8]. In the data communication system according to [7],
the substitute data is relevant data related to the collection data.
[9]. In the data communication system according to [7],
the substitute data is calculated data obtained by calculation based on relevant data related to the collection data.

What is claimed is:

1. A data communication system comprising
a center device and a vehicular device mounted on a vehicle which are capable of data communication with each other,
wherein the center device includes at least one processor that executes a program and/or at least one dedicated circuit, implementing:
a delivery target specifier that, based on vehicle equipment, specifies a delivery target to which a trigger condition for detecting a given scene of the vehicle is delivered;
a trigger condition generator that generates the trigger condition that corresponds to the delivery target;
a collection data list generator that generates a collection data list that corresponds to the trigger condition;
a deliverer that delivers the trigger condition and the collection data list to the vehicular device of the delivery target; and
a data acquirer that acquires collection data indicated in the collection data list from the vehicular device, and
wherein the vehicular device at least one processor that executes a program and/or at least one dedicated circuit, implementing:
a detection data acquirer that acquires detection data required for a trigger condition determination;
a trigger condition determiner that performs the trigger condition determination based on the detection data according to the trigger condition;
a collection data generator that generates the collection data based on a determination result of the trigger condition determination; and
a collection data transmitter that transmits the collection data to the center device,
wherein the delivery target specifier specifies the delivery target based on a driver characteristic in addition to the vehicle equipment.

2. The data communication system according to claim 1, wherein:
the delivery target specifier specifies the delivery target based on a collection time period for collecting the collection data in addition to the vehicle equipment.

3. The data communication system according to claim 1, wherein:
the deliverer delivers the trigger condition and the collection data list to the vehicular device of the delivery target in response to a driving mechanism starting operating in the vehicle of the delivery target.

4. The data communication system according to claim 3, wherein:
the deliverer delivers the trigger condition and the collection data list to the vehicular device of the delivery target in response to changing drivers in the vehicle of the delivery target.

5. A data communication system comprising
a center device and a vehicular device mounted on a vehicle which are capable of data communication with each other,
wherein the center device includes at least one processor that executes a program and/or at least one dedicated circuit, implementing:
a delivery target specifier that, based on vehicle equipment, specifies a delivery target to which a trigger condition for detecting a given scene of the vehicle is delivered;
a trigger condition generator that generates the trigger condition that corresponds to the delivery target;
a collection data list generator that generates a collection data list that corresponds to the trigger condition;
a deliverer that delivers the trigger condition and the collection data list to the vehicular device of the delivery target; and
a data acquirer that acquires collection data indicated in the collection data list from the vehicular device, and
wherein the vehicular device includes at least one processor that executes a program and/or at least one dedicated circuit, implementing:
a detection data acquirer that acquires detection data required for a trigger condition determination;
a trigger condition determiner that performs the trigger condition determination based on the detection data according to the trigger condition;
a collection data generator that generates the collection data based on a determination result of the trigger condition determination; and
a collection data transmitter that transmits the collection data to the center device,
wherein
the deliverer delivers the trigger condition and the collection data list to the vehicular device of the delivery target in response to completing a software update of an electronic control unit in the vehicle of the delivery target.

6. A data communication system comprising
a center device and a vehicular device mounted on a vehicle which are capable of data communication with each other,
wherein the center device includes at least one processor that executes a program and/or at least one dedicated circuit, implementing:
a delivery target specifier that, based on vehicle equipment, specifies a delivery target to which a trigger condition for detecting a given scene of the vehicle is delivered;
a trigger condition generator that generates the trigger condition that corresponds to the delivery target;
a collection data list generator that generates a collection data list that corresponds to the trigger condition;
a deliverer that delivers the trigger condition and the collection data list to the vehicular device of the delivery target;
a data acquirer that acquires collection data indicated in the collection data list from the vehicular device;
a substitute data list generator that generates a substitute data list serving as a substitute for the collection data list; and
a substitute data acquirer that acquires substitute data indicated in the substitute data list from the vehicular device,
wherein the deliverer delivers the trigger condition, the collection data list, and the substitute data list to the vehicular device of the delivery target,
wherein the vehicular device includes:
a detection data acquirer that acquires detection data required for a trigger condition determination;
a trigger condition determiner that performs the trigger condition determination based on the detection data according to the trigger condition;
a collection data generator that generates the collection data based on a determination result of the trigger condition determination;
a collection data transmitter that transmits the collection data to the center device;
a substitute data generator that generates the substitute data when the collection data generator is unable to generate the collection data based on the determination result of the trigger condition determination; and
a substitute data transmitter that transmits the substitute data to the center device,
wherein the substitute data is a calculated data obtained by calculation based on relevant data related to the collection data.

7. A center device capable of data communication with a vehicular device mounted on a vehicle, wherein the vehicular device performs a trigger condition determination based on detection data required for the trigger condition determination, generates collection data based on a determination result of the trigger condition determination, and transmits the collection data to the center device,
the center device comprising at least one processor that executes a program and/or at least one dedicated circuit, implementing:
a delivery target specifier that, based on vehicle equipment, specifies a delivery target to which a trigger condition for detecting a given scene of the vehicle is to be delivered;
a trigger condition generator that generates the trigger condition that corresponds to the delivery target;
a collection data list generator that generates a collection data list that corresponds to the trigger condition;
a deliverer that delivers the trigger condition and the collection data list to the vehicular device of the delivery target; and
a data acquirer that acquires the collection data from the vehicular device,
wherein the delivery target specifier specifies the delivery target based on a driver characteristic in addition to the vehicle equipment.

8. A center device capable of data communication with a vehicular device mounted on a vehicle, wherein the vehicular device performs a trigger condition determination based on detection data required for the trigger condition determination, generates collection data based on a determination result of the trigger condition determination, and transmits the collection data to the center device,
the center device comprising at least one processor that executes a program and/or at least one dedicated circuit, implementing:
a delivery target specifier that, based on vehicle equipment, specifies a delivery target to which a trigger condition for detecting a given scene of the vehicle is to be delivered;
a trigger condition generator that generates the trigger condition that corresponds to the delivery target;
a collection data list generator that generates a collection data list that corresponds to the trigger condition;
a deliverer that delivers the trigger condition and the collection data list to the vehicular device of the delivery target; and
a data acquirer that acquires the collection data from the vehicular device,
wherein the deliverer delivers the trigger condition and the collection data list to the vehicular device of the delivery target in response to completing a software update of an electronic control unit in the vehicle of the delivery target.

9. A center device capable of data communication with a vehicular device mounted on a vehicle, wherein the vehicular device performs a trigger condition determination based on detection data required for the trigger condition determination, generates collection data based on a determination result of the trigger condition determination, and transmits the collection data to the center device,
the center device comprising at least one processor that executes a program and/or at least one dedicated circuit, implementing:
a delivery target specifier that, based on vehicle equipment, specifies a delivery target to which a trigger condition for detecting a given scene of the vehicle is to be delivered;
a trigger condition generator that generates the trigger condition that corresponds to the delivery target;
a collection data list generator that generates a collection data list that corresponds to the trigger condition;
a deliverer that delivers the trigger condition and the collection data list to the vehicular device of the delivery target;
a data acquirer that acquires the collection data from the vehicular device;
a substitute data list generator that generates a substitute data list serving as a substitute for the collection data list; and
a substitute data acquirer that acquires substitute data indicated in the substitute data list from the vehicular device,
wherein the deliverer delivers the trigger condition, the collection data list, and the substitute data list to the vehicular device of the delivery target,
wherein the substitute data is a calculated data obtained by calculation based on relevant data related to the collection data.

10. A data processing method executed in a data communication system in which a center device and a vehicular device mounted on a vehicle are capable of data communication,
the data processing method comprising
in the center device:
based on vehicle equipment, specifying a delivery target to which a trigger condition for detecting a given scene of the vehicle is delivered;
generating the trigger condition that corresponds to the delivery target;
generating a collection data list that corresponds to the trigger condition;
delivering the trigger condition and the collection data list to the vehicular device of the delivery target; and
acquiring collection data indicated in the collection data list from the vehicular device,
the data processing method further comprising
in the vehicular device:
acquiring detection data required for a trigger condition determination;
performing the trigger condition determination based on the detection data;
generating collection data based on a determination result of the trigger condition determination; and
transmitting the collection data to the center device,
wherein specifying the delivery target includes specifying the delivery target based on a driver characteristic in addition to the vehicle equipment.

11. A data processing method executed in a data communication system in which a center device and a vehicular device mounted on a vehicle are capable of data communication,
the data processing method comprising
in the center device:
based on vehicle equipment, specifying a delivery target to which a trigger condition for detecting a given scene of the vehicle is delivered;
generating the trigger condition that corresponds to the delivery target;
generating a collection data list that corresponds to the trigger condition;
delivering the trigger condition and the collection data list to the vehicular device of the delivery target; and
acquiring collection data indicated in the collection data list from the vehicular device,
the data processing method further comprising
in the vehicular device:
acquiring detection data required for a trigger condition determination;
performing the trigger condition determination based on the detection data;
generating collection data based on a determination result of the trigger condition determination; and
transmitting the collection data to the center device,
wherein
delivering the trigger condition and the collection data list includes delivering the trigger condition and the collection data list to the vehicular device of the delivery target in response to completing a software update of an electronic control unit in the vehicle of the delivery target.

12. A data processing method executed in a data communication system in which a center device and a vehicular device mounted on a vehicle are capable of data communication,
the data processing method comprising
in the center device:
based on vehicle equipment, specifying a delivery target to which a trigger condition for detecting a given scene of the vehicle is delivered;
generating the trigger condition that corresponds to the delivery target;
generating a collection data list that corresponds to the trigger condition;
delivering the trigger condition and the collection data list to the vehicular device of the delivery target;
acquiring collection data indicated in the collection data list from the vehicular device;
generating a substitute data list serving as a substitute for the collection data list; and
acquiring substitute data indicated in the substitute data list from the vehicular device,
wherein delivering the trigger condition and the collection data list includes delivering the trigger condition, the collection data list, and the substitute data list to the vehicular device of the delivery target,
the data processing method further comprising
in the vehicular device:
acquiring detection data required for a trigger condition determination;
performing the trigger condition determination based on the detection data;
generating collection data based on a determination result of the trigger condition determination; and
transmitting the collection data to the center device,
wherein the substitute data is a calculated data obtained by calculation based on relevant data related to the collection data.

13. A data processing method executed in a center device capable of data communication with a vehicular device mounted on a vehicle, wherein the vehicular device performs a trigger condition determination based on detection data required for the trigger condition determination, generates collection data based on a determination result of the trigger condition determination, and transmits the collection data to the center device,
the data processing method comprising:
based on vehicle equipment, specifying a delivery target to which a trigger condition for detecting a given scene of the vehicle is delivered;
generating the trigger condition that corresponds to the delivery target;
generating a collection data list that corresponds to the trigger condition;
delivering the trigger condition and the collection data list to the vehicular device of the delivery target; and
acquiring the collection data from the vehicular device,
wherein specifying a delivery target includes specifying the delivery target based on a driver characteristic in addition to the vehicle equipment.

14. A data processing method executed in a center device capable of data communication with a vehicular device mounted on a vehicle, wherein the vehicular device performs a trigger condition determination based on detection data required for the trigger condition determination, generates collection data based on a determination result of the trigger condition determination, and transmits the collection data to the center device,
the data processing method comprising:
based on vehicle equipment, specifying a delivery target to which a trigger condition for detecting a given scene of the vehicle is delivered;
generating the trigger condition that corresponds to the delivery target;
generating a collection data list that corresponds to the trigger condition;
delivering the trigger condition and the collection data list to the vehicular device of the delivery target; and
acquiring the collection data from the vehicular device,
wherein
delivering the trigger condition and the collection data list includes delivering the trigger condition and the collection data list to the vehicular device of the delivery target in response to completing a software update of an electronic control unit in the vehicle of the delivery target.

15. A data processing method executed in a center device capable of data communication with a vehicular device mounted on a vehicle, wherein the vehicular device performs a trigger condition determination based on detection data required for the trigger condition determination, generates collection data based on a determination result of the trigger condition determination, and transmits the collection data to the center device,
the data processing method comprising:
based on vehicle equipment, specifying a delivery target to which a trigger condition for detecting a given scene of the vehicle is delivered;
generating the trigger condition that corresponds to the delivery target;
generating a collection data list that corresponds to the trigger condition;
delivering the trigger condition and the collection data list to the vehicular device of the delivery target; and
acquiring the collection data from the vehicular device,
generating a substitute data list serving as a substitute for the collection data list; and
acquiring substitute data indicated in the substitute data list from the vehicular device,
wherein delivering the trigger condition and the collection data list includes delivering the trigger condition, the collection data list, and the substitute data list to the vehicular device of the delivery target,
wherein the substitute data is a calculated data obtained by calculation based on relevant data related to the collection data.

16. A data processing program stored in a non-transitory storage medium for a center device capable of data communication with a vehicular device mounted on a vehicle, wherein the vehicular device performs a trigger condition determination based on detection data required for the trigger condition determination, generates collection data based on a determination result of the trigger condition determination, and transmits the collection data to the center device,
the data processing program causing the center device to execute:
based on vehicle equipment, specifying a delivery target to which a trigger condition for detecting a given scene of the vehicle is delivered;
generating the trigger condition that corresponds to the delivery target;
generating a collection data list that corresponds to the trigger condition;
delivering the trigger condition and the collection data list to the vehicular device of the delivery target; and
acquiring the collection data from the vehicular device,
wherein specifying the delivery target includes specifying the delivery target based on a driver characteristic in addition to the vehicle equipment.

17. A data processing program stored in a non-transitory storage medium for a center device capable of data communication with a vehicular device mounted on a vehicle, wherein the vehicular device performs a trigger condition determination based on detection data required for the trigger condition determination, generates collection data based on a determination result of the trigger condition determination, and transmits the collection data to the center device,
the data processing program causing the center device to execute:
based on vehicle equipment, specifying a delivery target to which a trigger condition for detecting a given scene of the vehicle is delivered;
generating the trigger condition that corresponds to the delivery target;
generating a collection data list that corresponds to the trigger condition;
delivering the trigger condition and the collection data list to the vehicular device of the delivery target; and
acquiring the collection data from the vehicular device,
wherein
delivering the trigger condition and the collection data list includes delivering the trigger condition and the collection data list to the vehicular device of the delivery target in response to completing a software update of an electronic control unit in the vehicle of the delivery target.

18. A data processing program stored in a non-transitory storage medium for a center device capable of data communication with a vehicular device mounted on a vehicle, wherein the vehicular device performs a trigger condition determination based on detection data required for the trigger condition determination, generates collection data based on a determination result of the trigger condition determination, and transmits the collection data to the center device,
the data processing program causing the center device to execute:
based on vehicle equipment, specifying a delivery target to which a trigger condition for detecting a given scene of the vehicle is delivered;
generating the trigger condition that corresponds to the delivery target;
generating a collection data list that corresponds to the trigger condition;
delivering the trigger condition and the collection data list to the vehicular device of the delivery target; and
acquiring the collection data from the vehicular device,
generating a substitute data list serving as a substitute for the collection data list; and
acquiring substitute data indicated in the substitute data list from the vehicular device,
wherein delivering the trigger condition and the collection data list includes delivering the trigger condition, the collection data list, and the substitute data list to the vehicular device of the delivery target,
wherein the substitute data is a calculated data obtained by calculation based on relevant data related to the collection data.
